(19) United States
(12) Patent Application Publication
(10) Pub. No.: US 2021/0367519 A1
(43) Pub. Date: Nov. 25, 2021

(54) METHOD AND APPARATUS FOR PHASE CURRENT BALANCING IN A MULTI-PHASE DC-TO-DC CONVERTER

(71) Applicant: Microchip Technology Incorporated, Chandler, AZ (US)

(72) Inventors: Surya Prakash Rao Talari, San Jose, CA (US); Alexander Mednik, Campbell, CA (US); Ioan Stoichita, Campbell, CA (US)

(73) Assignee: Microchip Technology Incorporated, Chandler, AZ (US)

(21) Appl. No.: 17/101,498

(22) Filed: Nov. 23, 2020

Related U.S. Application Data
(60) Provisional application No. 63/028,461, filed on May 21, 2020.

(51) Int. Cl. H02M 3/158; H02M 1/00

(52) U.S. Cl. CPC H02M 3/1584; H02M 2001/0009; H02M 2003/1586; H02M 1/00

(57) ABSTRACT

A multi-phase DC-to-DC controller is provided. The controller includes a plurality of current sense circuits that sense current in respective converter cell of the converter, and generate respective current sense signals, an averaging circuit that receives the respective current sense signals and generates an average signal, a plurality of error detector circuits that compare respective current sense signals with the average signal and generate respective voltage imbalance signals, a plurality of transconductor circuits that convert respective voltage imbalance signals to respective current imbalance signals, and a plurality of pulse width modulation (PWM) generators that output PWM signals to control respective converter cells based on a comparison between a ramp threshold voltage of the PWM generators and a PWM ramp voltage that is based on the sum of one of the respective current imbalance signals and a first current that is proportional to the input voltage.

### CROSS-REFERENCE TO RELATED APPLICATION

This application claims the benefit of U.S. Provisional Patent Application No. 63/028,461, filed on May 21, 2020, which is incorporated herein by reference in its entirety.

### TECHNICAL FIELD

The present disclosure generally relates to multi-phase DC-to-DC converters and more particularly to a method and apparatus for achieving output current balance between phases.

### BACKGROUND

In a multi-phase DC-to-DC power converter, balance between currents in all phases needs to be considered. Imbalance in output current between phases can cause uneven heat distribution, which adversely affects performance, power efficiency, and size of the power converter. Pulse-width modulation (PWM) control of multiple continuous conduction-mode (CCM) power converters configured to share a common load will not necessarily achieve sharing the output current equally between these converters. A consideration should be taken in the control method to achieve the current balance between phases.

Voltage Mode Control-based (VMC) converters have been popular for their exceptional noise immunity, simple single loop control, and ability to control relatively short on-time periods. Numerous schemes have been proposed for achieving output current balance between phases by altering the duty ratio of a phase in proportion with the deviation of its current from the average of all phases. FIG. 1 depicts an example of such a prior-art DC-to-DC VMC controller, wherein the inductor current of each of N phases, IL₁˜IL_{N}, is monitored by a respective current sense amplifier 101 and compared by a respective error detector circuit 105 to an average current of all N phases V_{CS(AV)} derived by an averaging circuit 102 after passing respective low-pass pass filters 103. The resulting imbalance voltage, ΔV_{CS1}˜ΔV_{CSN}, is subtracted from a ramp threshold voltage V_{COMP} of a PWM generator 107 at a respective difference circuit 106. The ramp threshold voltage V_{COMP} is generated by an error amplifier circuit 110 as a function of the error between the output voltage V_{OUT} and a fixed reference voltage V_{REF}, and the ramp voltage of each respective PWM generator 107 is generated from a current through a timing resistor R_{T}, the amplitude of which is proportional to the input voltage V_{IN} (input feed forward) of the power converter. Alternatively, the timing resistor R_{T} could be replaced with a current source that is proportional to the input voltage V_{IN}.

Due to the presence of significant switching ripple component in the inductor current, low-pass filters 103 are required to achieve current balancing. These filters affect the current balancing loop dynamics and, therefore, degrade the load transient response.

### SUMMARY

According to an aspect of one or more exemplary embodiments, a multi-phase DC-to-DC controller for receiving an input voltage and delivering an output voltage to a load by splitting the load current between a plurality of DC-to-DC converter cells is provided. The controller may include a plurality of current sense circuits each configured to sense current in a respective one of the plurality of converter cells, each of the plurality of current sense circuits configured to generate a respective current sense signal, an averaging circuit configured to receive each of the respective current sense signals and generate an average signal that represents an average of the respective current sense signals, a plurality of error detector circuits each configured to compare a respective current sense signal with the average signal and generate a respective voltage imbalance signal, a plurality of transconductor circuits each configured to convert a respective voltage imbalance signal to a respective current imbalance signal, and a plurality of pulse width modulation (PWM) generators each configured to output a PWM signal configured to control a respective one of the plurality of converter cells based on a comparison between a ramp threshold voltage of the plurality of PWM generators and a PWM ramp voltage that is based on a sum of one of the respective current imbalance signals and a first current that is proportional to the input voltage.

According to one or more exemplary embodiments, each of the plurality of PWM generators may include a source of the first current, which may be a timing resistor configured to generate the first current that is proportional to the input voltage. Alternatively, each of the PWM generators may include a current source that generates the first current in proportion to the input voltage. Each of the plurality of PWM generators may also include a timing capacitor configured to integrate a sum of the first current and a respective current imbalance signal and generate the PWM ramp voltage, and a comparator for outputting a PWM signal based on whether the PWM ramp voltage exceeds the ramp threshold voltage. The first current may be substantially proportional to the input voltage.

According to one or more exemplary embodiments, the controller may include a plurality of multiplier-divider circuits each configured to multiply a respective voltage imbalance signal by a ratio of the input voltage and the ramp threshold voltage, and to generate a respective normalized voltage imbalance signal. The respective voltage imbalance signal converted by each of the plurality of transconductor circuits may be the normalized voltage imbalance signal generated by the plurality of multiplier-divider circuits.

According to one or more exemplary embodiments, the controller may include a ramp threshold voltage generator circuit configured to generate the ramp threshold voltage based on a comparison between the output voltage and a reference voltage.

According to another aspect of one or more exemplary embodiments, there is provided a method in a multi-phase DC-to-DC controller for receiving an input voltage and delivering an output voltage to a load by splitting the load current between a plurality of DC-to-DC converter cells. The method may include sensing current in a respective one of the plurality of converter cells and generating a respective current sense signal, generating an average signal that represents an average of the respective current sense signals, comparing a respective current sense signal with the average signal and generating a respective voltage imbalance signal, converting a respective voltage imbalance signal to a respective current imbalance signal, and outputting a PWM signal configured to control a respective one of the plurality of converter cells based on a comparison between a ramp threshold voltage and a PWM ramp voltage that is based on a sum of one of the respective current imbalance signals and a first current that is proportional to the input voltage.

The method may further include integrating a sum of the first current and a respective current imbalance signal to generate a PWM ramp voltage, and outputting a PWM signal based on whether the PWM ramp voltage exceeds the ramp threshold voltage. The first current may be substantially proportional to the input voltage.

According to one or more exemplary embodiments, the method may further include multiplying a respective current imbalance signal by a ratio of the input voltage and the ramp threshold voltage to generate a normalized voltage imbalance signal. Converting a respective voltage imbalance signal to a respective current imbalance signal may include converting the normalized voltage imbalance signal to a normalized respective current imbalance signal. The ramp threshold voltage of the PWM generator may be generated based on a comparison between the output voltage and a reference voltage.

According to another aspect of one or more exemplary embodiments, there is provided a multi-phase DC-to-DC controller for receiving an input voltage and delivering an output voltage to a load by splitting the load current between a plurality of DC-to-DC converter cells. The controller may include a plurality of current sense circuits each configured to sense current in a respective one of the plurality of converter cells, each of the plurality of current sense circuits configured to generate a respective current sense signal, an averaging circuit configured to receive each of the respective current sense signals and generate an average signal that represents an average of the respective current sense signals, a plurality of error detector circuits each configured to compare a respective current sense signal with the average signal and generate a respective voltage imbalance signal, a plurality of multiplier-divider circuits each configured to multiply a respective voltage imbalance signal by a ratio of the input voltage and a ramp threshold voltage to generate a respective normalized voltage imbalance signal, a plurality of transconductor circuits each configured to convert a respective normalized voltage imbalance signal to a respective normalized current imbalance signal, a plurality of pulse width modulation (PWM) generators each configured to output a PWM signal configured to control a respective one of the plurality of converter cells based on a comparison between the ramp threshold voltage and a PWM ramp voltage that based on a sum of one of the respective normalized current imbalance signals and a first current that is proportional to the input voltage, and a ramp threshold voltage generator circuit configured to generate the ramp threshold voltage based on a comparison between the output voltage and a reference voltage. Each of the plurality of PWM generators may include a source of the first current that is proportional to the input voltage, which may be include a timing resistor coupled to the input voltage to generate the first current, a timing capacitor configured to integrate a sum of the first current and a respective current imbalance signal and generate a PWM ramp voltage, and a comparator for outputting a PWM signal based on a comparison between the PWM ramp voltage and the ramp threshold voltage.

### BRIEF DESCRIPTION OF DRAWINGS

A more complete understanding of the present embodiments, and the attendant advantages and features thereof, will be more readily understood by reference to the following detailed description when considered in conjunction with the accompanying drawings wherein:

FIG. 1 shows a circuit diagram of a prior art DC to DC controller;

FIG. 2 shows a circuit diagram of a DC to DC controller according to an exemplary embodiment;

FIG. 3 shows a PWM generator including a multiplier-divider circuit configured to normalize the current balancing loop gain of the DC to DC controller according to an exemplary embodiment; and

FIG. 4 shows a circuit diagram of a DC to DC controller according to an exemplary embodiment.

### DETAILED DESCRIPTION OF EXEMPLARY EMBODIMENTS

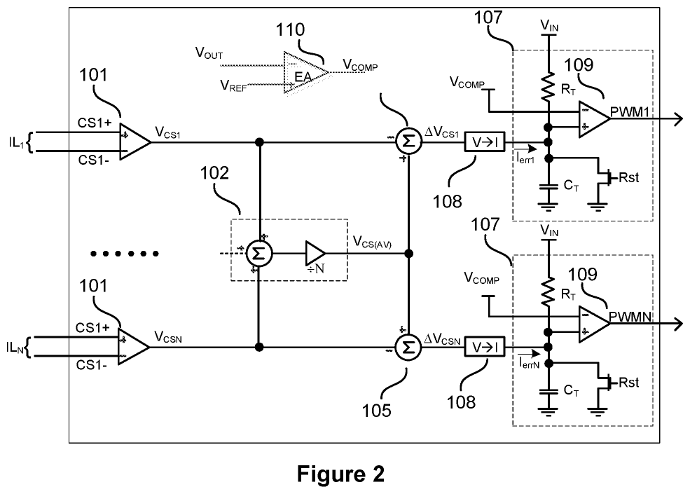

FIG. 2 illustrates a multi-phase DC-to-DC controller according to an exemplary embodiment. The multiphase DC to DC controller is implemented as a VMC controller, particularly suitable for use as a buck converter with a plurality of buck-converter cells. The exemplary converter is configured to receive an input voltage and deliver an output voltage to a load by splitting the load current between a plurality of DC-to-DC converter cells (not shown). In this exemplary embodiment, the multi-phase DC-to-DC controller includes respective current sense amplifiers 101, each of which monitors the inductor current of a respective one of N phases, IL₁˜IL_{N} and senses current in the respective one of a plurality of converter cells at respective current sense inputs CS1+, CS1−. Each of the current sense amplifiers 101 is configured to generate a respective current sense signal V_{CS1} through V_{CSN}. Averaging circuit 102 derives an average current for all of the N phases and is configured to receive the respective current sense signals and generate an average signal V_{CS(AV)} that represents an average of the respective current sense signals received by the averaging circuit 102. In one embodiment, as illustrated, averaging circuit 102 is implemented with a summing circuit arranged to sum the respective current sense signals V_{CS1} through V_{CSN}, followed by a divider circuit arranged to divide the resultant sum by the number of the respective current sense signals. Respective error detector circuits 105 are each configured to compare a respective current sense signal V_{CS1} through V_{CSN} with the average signal V_{CS(AV)} and generate a respective voltage imbalance signal ΔV_{CS1}˜ΔV_{CSN}. As shown in the exemplary embodiment of FIG. 2, the voltage imbalance signals, ΔV_{CS1}˜ΔV_{CSN}, may be converted to respective current imbalance signals, Iₑᵣᵣ₁˜I_{errN}, using a plurality of respective transconductor circuits 108.

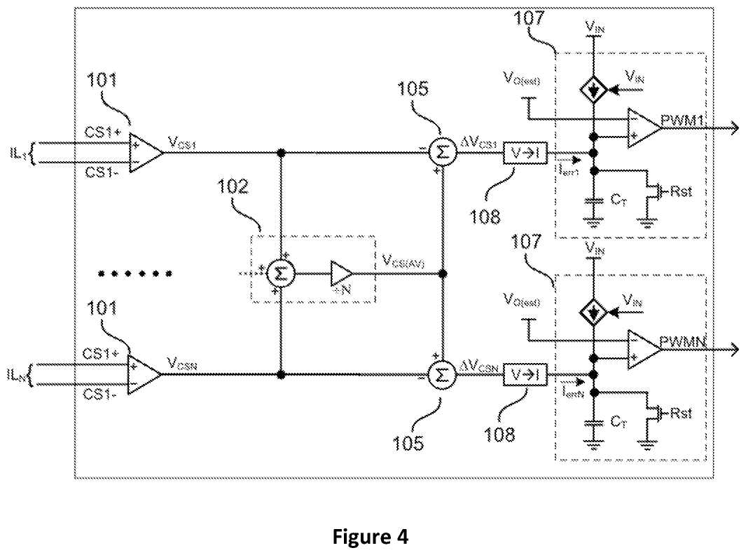

The multi-phase DC-to-DC controller shown in the exemplary embodiment of FIG. 2 may also include a plurality of PWM generators 107 configured to generate respective PWM signals PWM1 through PWMN for control of respective ones of the plurality of DC-to-DC converter cells. Each of the plurality of PWM generators 107 may include a source of a first current, which in FIG. 2 may preferably be a first current through timing resistor R_{T} the amplitude of which is proportional to the input voltage V_{IN}, a timing capacitor C_{T} configured to integrate a sum of the first current and a respective current imbalance signal Iₑᵣᵣ received from a respective transconductor circuit 108 to generate a PWM ramp voltage, and a comparator 109 configured to output the respective PWM signal PWM1 through PWMN based on a comparison of the PWM ramp voltage and a given ramp threshold voltage, e.g., V_{COMP}. In the embodiment shown, the respective PWM signal is an active high when the respective PWM ramp voltage exceeds the ramp threshold voltage, V_{COMP}. Although the PWM generators 107 shown in FIG. 2 each include a respective timing resistor R_{T} coupled between input voltage V_{IN} and the positive terminal of the comparator 109, each of the PWM generators 107 may alternatively include a current source (as shown in FIG. 4) that generates the first current, the amplitude of which may be proportional to the input voltage V_{IN}. As shown in FIG. 2, the PWM generator 107 may also include a switch Rst coupled in parallel with timing capacitor C_{T}, both of which are coupled between the positive terminal of the comparator 109 and ground. The negative terminal of the comparator 109 may be coupled to the ramp threshold voltage V_{COMP}. The ramp threshold voltage V_{COMP} is generated by an error amplifier circuit 110 as a function of the error between the output voltage V_{OUT} and a fixed reference voltage V_{REF}. The switch Rst may be used to reset the voltage across the timing capacitor C_{T} responsive to a respective control signal.

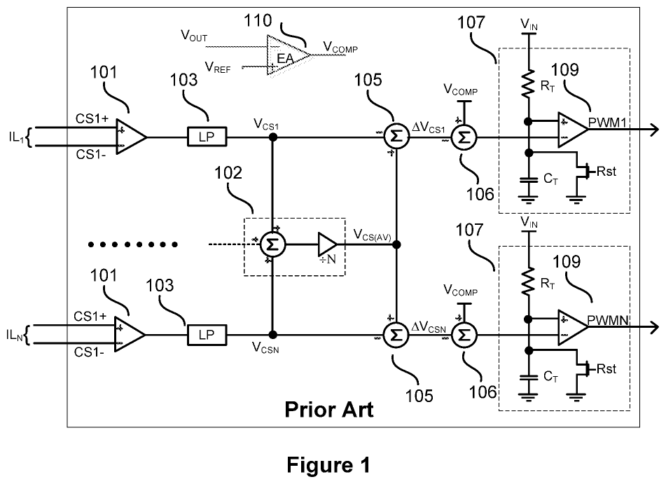

As explained above, a respective current imbalance signal Iₑᵣᵣ₁˜I_{errN} is summed with the first current through the timing resistor R_{T} at the timing capacitor C_{T}. Advantageously, integration of respective current imbalance signal Iₑᵣᵣ₁˜I_{errN} and the first current negates the effect of the ripple current component, and the filters 103 shown in the prior art converter of FIG. 1 can be eliminated, which may improve the load transient response.

According to another exemplary embodiment, preconditioning of the loop gain with respect to V_{IN} and V_{COMP} may be achieved. More specifically, the small-signal relationship between \tilde{d}, V_{COMP}, Iₑᵣᵣ, and V_{IN} can be given as:

$$\tilde{d} = \frac{{R}_{T} {C}_{T}}{{V}_{IN} {T}_{S}} \cdot ( {\tilde{v}}_{COMP} - \frac{{V}_{COMP}}{{V}_{IN}} \cdot {\tilde{v}}_{IN} - \frac{{R}_{T} {V}_{COMP}}{{V}_{IN}} {\tilde{i}}_{err} ) \qquad ( 1 )$$

where \tilde{d} is the small-signal duty ratio of the converter,
ĩₑᵣᵣ the small signal change of the current imbalance signal I_{errN},
\tilde{v}_{IN} is the small signal change of the input voltage V_{IN},
\tilde{v}_{COMP} is the small signal change of the ramp threshold voltage V_{COMP}, and
T_{S} is the switching period.

Setting \tilde{v}_{COMP} and \tilde{v}_{IN} to zero, a small-signal relationship between Iₑᵣᵣ and the steady state switching node voltage V_{SW} (which is in the subsequent power stage, and not shown in the Figures) can be given as:

$${\tilde{v}}_{SW} {\text{\textbar}}_{{{\tilde{v}}_{COMP} = 0}_{{\tilde{v}}_{IN} = 0}} = {V}_{IN} \cdot \tilde{d} = - \frac{{R}_{T}^{2} {C}_{T}}{{T}_{S}} \cdot \frac{{V}_{COMP}}{{V}_{IN}} \cdot {\tilde{i}}_{err} \qquad ( 2 )$$

wherein \tilde{v}_{SW} is the small signal voltage change at the switching node.

By pre-conditioning Iₑᵣᵣ with respect to V_{COMP}/V_{IN}, a constant current share loop gain can be achieved at any V_{COMP} and V_{IN}.

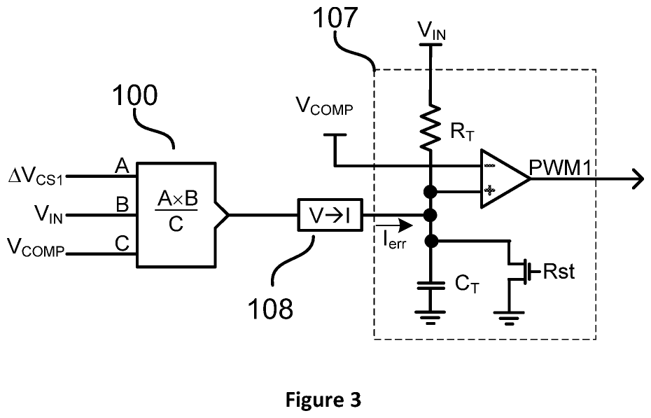

FIG. 3 shows a PWM generator 107 according to an exemplary embodiment that may achieve constant current share loop gain at any V_{COMP} and V_{IN}. Referring to FIG. 3, the exemplary multi-phase DC-to-DC VMC controller may include a plurality of multiplier-divider circuits 100 whose outputs are respectively coupled to the transconductor circuits 108, and are configured to normalize the current balancing loop gain. Each of the multiplier-divider circuits 100 of FIG. 3 may receive as inputs a respective imbalance voltage ΔV_{CS1}, input voltage V_{IN}, and ramp threshold voltage V_{COMP}. The multiplier-divider circuit 100 may multiply the respective imbalance voltage ΔV_{CS1} by the input voltage V_{IN}, and divide the respective imbalance voltage ΔV_{CS1} by the ramp threshold voltage V_{COMP}. As shown in FIG. 3, the resulting voltage may be input to the transconductor circuit 108, which converts the input voltage to a respective current imbalance signal Iₑᵣᵣ₁˜I_{errN}.

Accordingly, Equation (2) may be modified as follows:

$${\tilde{v}}_{SW} {\text{\textbar}}_{{{\tilde{v}}_{COMP} = 0}_{{\tilde{v}}_{IN} = 0}} = {V}_{IN} \cdot \tilde{d} = \frac{{R}_{T}^{2} {C}_{T} \cdot {g}_{m}}{{T}_{S}} \cdot {\tilde{v}}_{CS} \qquad ( 3 )$$

where gₘ is the gain of the transconductor circuit 108, and \tilde{v}_{CS} is the small signal change of a respective current sense signal output by a respective current sense amplifier 101. As shown in Equation (3), the gain R_{T}²C_{T}gₘ/T_{S} may be invariant with respect to V_{IN} and V_{COMP}. Thus, in this exemplary embodiment, the multi-phase DC-to-DC controller may include a plurality of multiplier-divider circuits 100, wherein each of the plurality of multiplier-divider circuits 100 is configured to multiply a respective current imbalance signal, i.e., ΔV_{CS1}˜ΔV_{CSN} by a ratio of the input voltage and the output voltage, and to generate a normalized current imbalance signal, which may be invariant with respect to V_{IN} and V_{COMP}.

Many different embodiments have been disclosed herein, in connection with the above description and the drawings. It will be understood that it would be unduly repetitious to literally describe and illustrate every combination and subcombination of these embodiments. Accordingly, all embodiments can be combined in any way and/or combination, and the present specification, including the drawings, shall be construed to constitute a complete written description of all combinations and sub combinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A multi-phase DC-to-DC controller for receiving an input voltage and delivering an output voltage to a load by splitting the load current between a plurality of DC-to-DC converter cells, the multi-phase DC-to-DC controller comprising:
a plurality of current sense circuits each configured to sense current in a respective one of the plurality of converter cells, each of the plurality of current sense circuits configured to generate a respective current sense signal;
an averaging circuit configured to receive each of the respective current sense signals and generate an average signal that represents an average of the respective current sense signals;
a plurality of error detector circuits each configured to compare a respective current sense signal with the average signal and generate a respective voltage imbalance signal;
a plurality of transconductor circuits each configured to convert a respective voltage imbalance signal to a respective current imbalance signal; and
a plurality of pulse width modulation (PWM) generators each configured to output a PWM signal configured to control a respective one of the plurality of converter cells based on a comparison between a ramp threshold voltage of the plurality of PWM generators and a respective PWM ramp voltage that is based on a sum of one of the respective current imbalance signals and a respective first current that is proportional to the input voltage.

2. The multi-phase DC-to-DC controller of claim 1, wherein each of the plurality of PWM generators comprises:
a timing resistor configured to generate the respective first current that is proportional to the input voltage;
a timing capacitor configured to integrate a sum of the respective first current and the respective current imbalance signal and generate the PWM ramp voltage; and
a comparator for outputting a respective PWM signal to activate the respective one of the plurality of converter cells, the respective PWM signal based on a comparison of the PWM ramp voltage and the ramp threshold voltage.

3. The multi-phase DC-to-DC controller of claim 1, further comprising:
a plurality of multiplier-divider circuits each configured to multiply a respective voltage imbalance signal by a ratio of the input voltage and the ramp threshold voltage, and to generate a respective normalized voltage imbalance signal;
wherein the respective voltage imbalance signal converted by each of the plurality of transconductor circuits is the normalized voltage imbalance signal generated by the plurality of multiplier-divider circuits.

4. The multi-phase DC-to-DC controller of claim 3, further comprising:
a ramp threshold voltage generator circuit configured to generate the ramp threshold voltage based on a comparison between the output voltage and a reference voltage.

5. The multi-phase DC-to-DC controller of claim 1, wherein each of the plurality of PWM generators comprises:
a current source configured to generate the respective first current that is proportional to the input voltage;
a timing capacitor configured to integrate a sum of the respective first current and a respective current imbalance signal and generate the respective PWM ramp voltage; and
a comparator for outputting a respective PWM signal configured to control the respective one of the plurality of converter cells, the respective PWM signal based on a comparison of the PWM ramp voltage and the ramp threshold voltage.

6. A method in a multi-phase DC-to-DC controller for receiving an input voltage and delivering an output voltage to a load by splitting the load current between a plurality of DC-to-DC converter cells, the method comprising:
sensing current in a respective one of the plurality of converter cells and generating a respective current sense signal;
generating an average signal that represents an average of the respective current sense signals;
comparing a respective current sense signal with the average signal and generating a respective voltage imbalance signal;
converting a respective voltage imbalance signal to a respective current imbalance signal; and
outputting a PWM signal configured to control a respective one of the plurality of converter cells based on a comparison between a ramp threshold voltage and a respective PWM ramp voltage that is based on a sum of one of the respective current imbalance signals and a first current that is proportional to the input voltage.

7. The method of claim 6, further comprising:
integrating a sum of the first current and the respective current imbalance signal to generate a PWM ramp voltage; and
outputting a PWM signal to activate the respective one of the plurality of converter cells based on a comparison of the PWM ramp voltage and the ramp threshold voltage.

8. The method of claim 6, further comprising:
multiplying a respective current imbalance signal by a ratio of the input voltage and the ramp threshold voltage to generate a normalized voltage imbalance signal;
wherein converting the respective voltage imbalance signal to the respective current imbalance signal comprises converting the normalized voltage imbalance signal to a normalized respective current imbalance signal.

9. The method of claim 8, wherein the ramp threshold voltage of the PWM generator is generated based on a comparison between the output voltage and a reference voltage.

10. A multi-phase DC-to-DC controller for receiving an input voltage and delivering an output voltage to a load by splitting the load current between a plurality of DC-to-DC converter cells, the controller comprising:
a plurality of current sense circuits each configured to sense current in a respective one of the plurality of converter cells, each of the plurality of current sense circuits configured to generate a respective current sense signal;
an averaging circuit configured to receive each of the respective current sense signals and generate an average signal that represents an average of the respective current sense signals;
a plurality of error detector circuits each configured to compare a respective current sense signal with the average signal and generate a respective voltage imbalance signal;
a plurality of multiplier-divider circuits each configured to multiply a respective voltage imbalance signal by a ratio of the input voltage and a ramp threshold voltage to generate a respective normalized voltage imbalance signal;
a plurality of transconductor circuits each configured to convert a respective normalized voltage imbalance signal to a respective normalized current imbalance signal; and
a plurality of pulse width modulation (PWM) generators each configured to output a PWM signal configured to control a respective one of the plurality of converter cells based on a comparison between the ramp threshold voltage and a respective PWM ramp voltage that based on a sum of one of the respective normalized current imbalance signals and a first current that is proportional to the input voltage;
wherein each of the plurality of PWM generators comprises:
a timing capacitor configured to integrate a sum of the first current and a respective current imbalance signal and generate the PWM ramp voltage; and
a comparator for outputting a PWM signal based on a comparison of the PWM ramp voltage and the ramp threshold voltage.

11. The multi-phase DC-to-DC controller of claim 10, wherein each of the plurality of PWM generators further comprises a timing resistor configured to generate the first current that is proportional to the input voltage.

12. The multi-phase DC-to-DC controller of claim 10, wherein each of the plurality of PWM generators further comprises a current source configured to generate the first current that is proportional to the input voltage.

13. The multi-phase DC-to-DC controller of claim 10, further comprising a ramp threshold voltage generator circuit configured to generate the ramp threshold voltage based on a comparison between the output voltage and a reference voltage.
